(19) United States
(12) Patent Application Publication
(10) Pub. No.: US 2012/0303279 A1
(43) Pub. Date: Nov. 29, 2012

(54) Inclinometer to Determine Orientation of Gauge Installed Off Center Axis of a Tubing String

(75) Inventor: Frank Cully Firmin, Lafayette, LA (US)

(73) Assignee: BAKER HUGHES INCORPORATED, HOUSTON, TX (US)

(21) Appl. No.: 13/362,248

(22) Filed: Jan. 31, 2012

Related U.S. Application Data
(60) Provisional application No. 61/437,976, filed on Jan. 31, 2011.

(51) Int. Cl. E21B 47/022; G06F 19/00

(52) U.S. Cl. 702/6; 33/302; 33/304

(57) ABSTRACT

A method and apparatus for estimating an orientation of a downhole device conveyed into a well on a conveyance device is disclosed. The apparatus includes a first sensor and a second sensor placed circumferentially spaced apart on the device to provide measurements relating to a selected downhole parameter. A processor is configured to estimate the orientation of the downhole device using a phase difference between the measurements of the first sensor and the second sensor.

### CROSS REFERENCE TO RELATED APPLICATIONS

This application claims priority to U.S. Provisional Application Ser. No. 61/437,976, filed on Jan. 31, 2011.

### FIELD OF THE DISCLOSURE

This disclosure relates generally to production well monitoring methods and more particularly to an apparatus and methods for determining the orientation of a monitoring device conveyed in a borehole.

### BACKGROUND OF THE DISCLOSURE

Gauge carriers have been developed for use in transporting and housing temperature/pressure gauges (sensors) in down-hole environments. These gauge carriers are commonly deployed using a tubular string. During the run-in process in the well, the tubular string may twist and create a rotational effect on the gauges and may cause the gauge carrier to have an unknown orientation down-hole. In a highly deviated well, the orientation may affect the measurements of the gauges. The present disclosure is directed towards an apparatus and methods for estimating the orientation of the gauge carrier.

### SUMMARY OF THE DISCLOSURE

In one aspect, the disclosure provides a method of estimating an orientation of a downhole device conveyed into a well on a conveyance device. In one embodiment, the method includes producing a first signal and a second signal indicative of a selected parameter using a first sensor and a second sensor respectively disposed circumferentially apart on the downhole device; and estimating orientation of the downhole device using a phase of a difference between the first signal and the second signal.

In another aspect, an apparatus for estimating orientation of a downhole device is provided. In one exemplary embodiment, the apparatus includes a first sensor and a second sensor placed circumferentially spaced apart on the device to provide measurements relating to a selected downhole parameter, and a processor configured to estimate the orientation of the downhole device using a phase difference between the measurements of the first sensor and the second sensor.

Examples of certain features of the apparatus and methods disclosed herein are summarized rather broadly in order that the detailed description thereof that follows may be better understood. There are, of course, additional features of the apparatus and methods disclosed hereinafter that will form the subject of the claims appended hereto.

### BRIEF DESCRIPTION OF THE DRAWINGS

The present disclosure is best understood with reference to the following figures in which like numerals refer to like elements, and in which:

FIG. 1 is a vertical cross section view of a well bore production string with a plurality of gauge carriers and surface monitoring systems;

FIG. 2 shows a portion of a flow meter gauge carrier including two pressure sensors;

FIG. 3 shows a cross-sectional view of the flow meter gauge carrier of FIG. 2;

FIG. 4 shows exemplary measurements made by the pressure sensors on the flow meter gauge of FIG. 2 caused by rotation of the tubing at a fixed depth; and

FIG. 5 shows measurements made by the pressure sensors on the flow meter gauge of FIG. 2 caused by rotation of the tubing during deployment in a deviated borehole.

### DETAILED DESCRIPTION OF THE DISCLOSURE

Monitoring the production flow of petroleum well is a practice common to reservoir engineers. In many cases permanent down-hole monitoring systems are deployed for monitoring multi-zone reservoirs and multilateral wells. Such systems may also be integrated with down-hole flow control devices in order to provide a response to the intelligence data gathered by down-hole instrumentation generally known as instrument sensors or simply as down-hole gauges. Such monitoring systems as pressure/temperature gauge assemblies, densitometers and flow meters are capable of recording data regarding the reservoir pressure and temperature, flow rates, fluid friction, sand detection, chemical properties and micro-seismic activity.

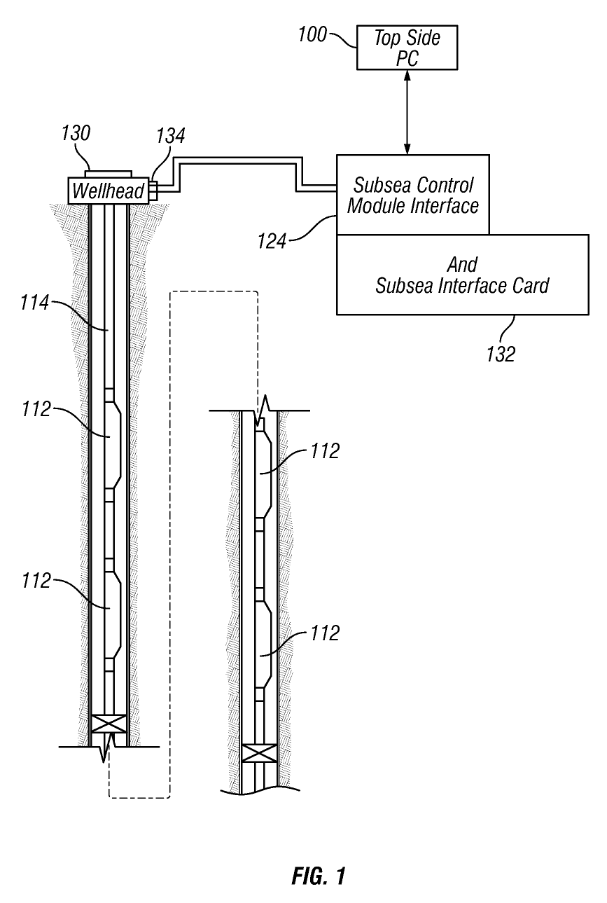

FIG. 1 shows an exemplary system for an offshore well. The system includes a surface data computer system 100 with a proprietary topside or sub-sea interface card (SIC) 132 and Sub-sea Electronics Module (SEM) 124. The computer system 100 may be located adjacent the well site or the data may be transmitted to remote locations for analysis. The computer system 100 communicates with sensor gauges positioned within gauge carriers 112 located at intervals along the tubing 114 by way of electrical or fiber optic cables or other such communication systems controlled by the surface computer communications system 100. The above-mentioned proprietary sub-sea interface cards 132 are designed for use with commercially available SEMs 124 for use with multiple instruments attached to a single cable. In use, the down-hole instruments or gauge assemblies digitize pressure, temperature and reference frequencies from one or more quartz transducers. This information is assembled into data packets that are transmitted to the proprietary sub sea interface card 132. In this installation, multiple down-hole gauges can transmit packets independently on the same cable. The proprietary sub sea card 132 reads the digital data packet, appends the card's status information and stores the data in MODBUS registers. On request the proprietary sub sea card 132 transmits the data to the computer system 100. The computer system 100 requests a data packet, reads it and converts it to engineering units. This down-hole digitization of signals allows for extremely high resolution.

Side pocket mandrel subs with full through bores are the preferred gauge carriers 112 for the gauge clusters disclosed herein and are generally coupled into the production string at desired zones along the well bore separated in many cases by hundreds of feet of tubing. These pocketed sub gauge carriers 112 and their unlimited gauge clusters assembly configurations constitute the basis for this disclosure. The gauge carrier or mandrel may be formed in a variety of ways.

However, the concept design is such that volumetric flow through the mandrel is unimpeded and is thus equal to the flow of the production tubing into which it is connected. As seen in FIG. 1, a single electrical penetration through the tubing hanger 130 is provided for supporting communication links 134 passing through the tubing hanger 130. These communication links are capable of connecting serial links to support redundant communications to multiple (at least three) combined pressure/temperature or flow meter down-hole gauges. A novel feature of the present disclosure is that the computer 100 is configured to use signals communicated by a downhole gauge carrier 112 to estimate the orientation of the carrier.

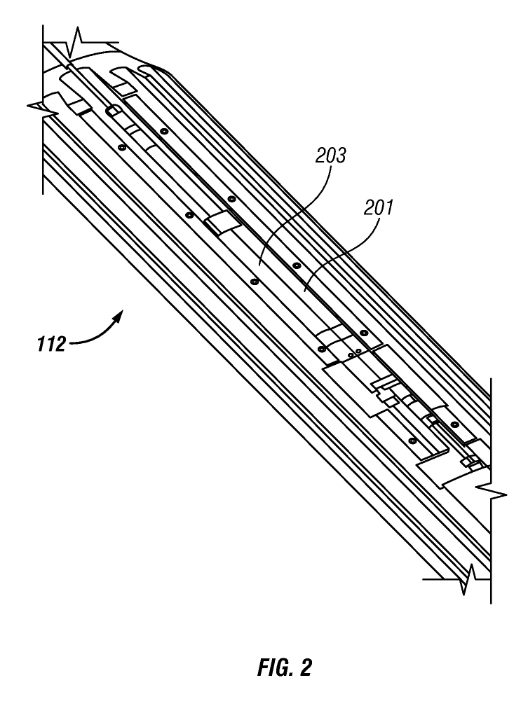

FIG. 2 shows a detail of a gauge carrier 112. This portion of the gauge carrier 112 includes two pressure sensors 201, 203. The pressure sensors such as 201, 203 may be used for flow rate measurements in the well. However, rotation of the tubing 112 during insertion of the gauge into the well can affect the measurements made by the pressure sensors 201, 203, particularly in a deviated borehole.

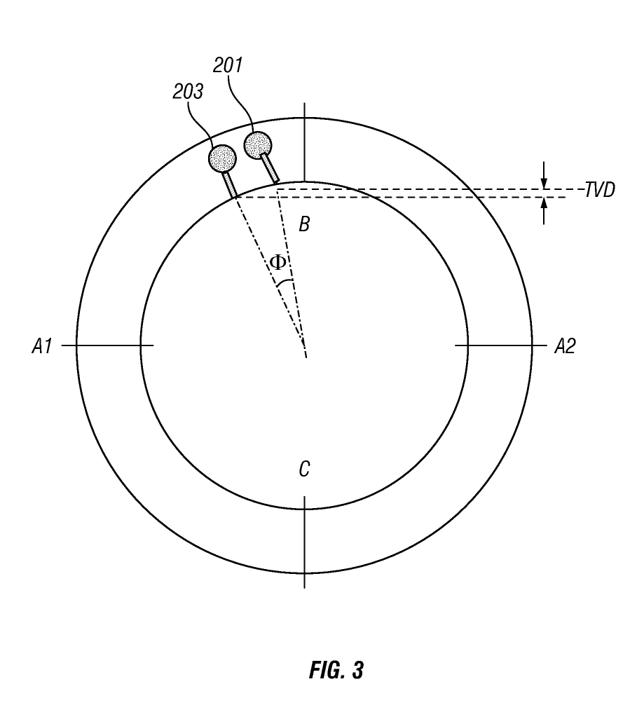

FIG. 3 shows a cross-sectional view of the gauge in which the sensors 201, 203 are offset by an angle Φ. This offset provides a small true vertical depth (TVD) in a deviated position. Due to this TVD and the fluid density, ρ in the pipe, there is a pressure differential between the pressure measurements made by the sensors 201, 203. These two sensors are spaced apart by a circumferential angle Φ.

The pressure difference is given by:

ΔP=TVD·ρ (1).

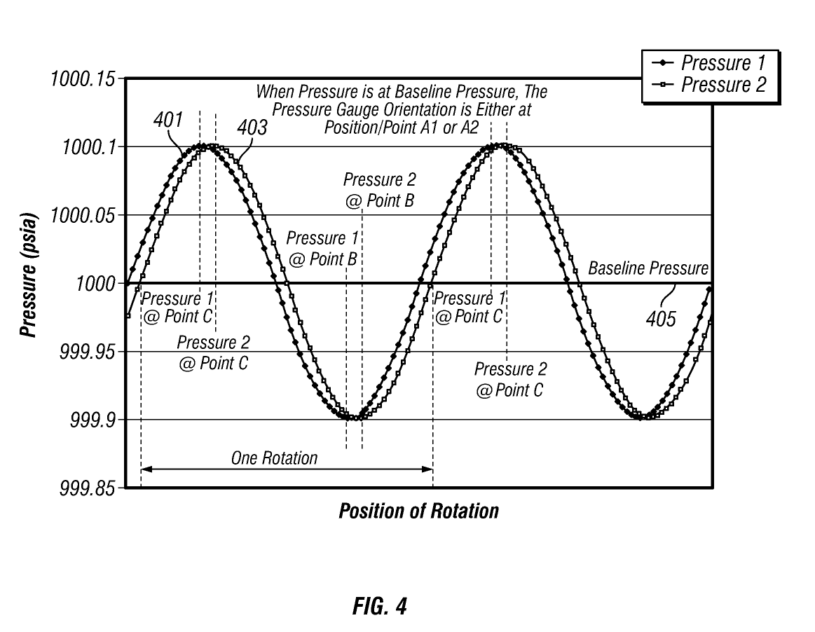

Turning now to FIG. 4, the effect of rotation of the gauge are shown. The abscissa is the rotation angle. Shown in the figure by 405 is the baseline pressure (1000 psia) in the tubing. Curves 401 and 403 are the pressures measured by 201 and 203 as a function of the rotation angle. It can be seen that the amount of changes in pressure is small. This particular example is for a fluid density of approximately 63 lb/ft³ with tubing diameter of 5.5″.

The tool goes through a sinusoidal pattern of pressure as shown in FIG. 4. Due to the hydrostatic head pressure that is exerted by the fluid in the tube, the pressure increases and decreases in this manner. There is an offset (phase shift) between the two sensors which is due to their TVD separation. The difference in pressure is a maximum near the baseline pressure. At either the troughs or peaks of the absolute pressure, the amount of difference in pressure between the two gauges is minimal, in some cases=0, as they cross-over. The offset in the two pressure measurements is a function of the circumferential separation between the two gauges, Φ:

Phase offset,φ=k·sin Φ (2)

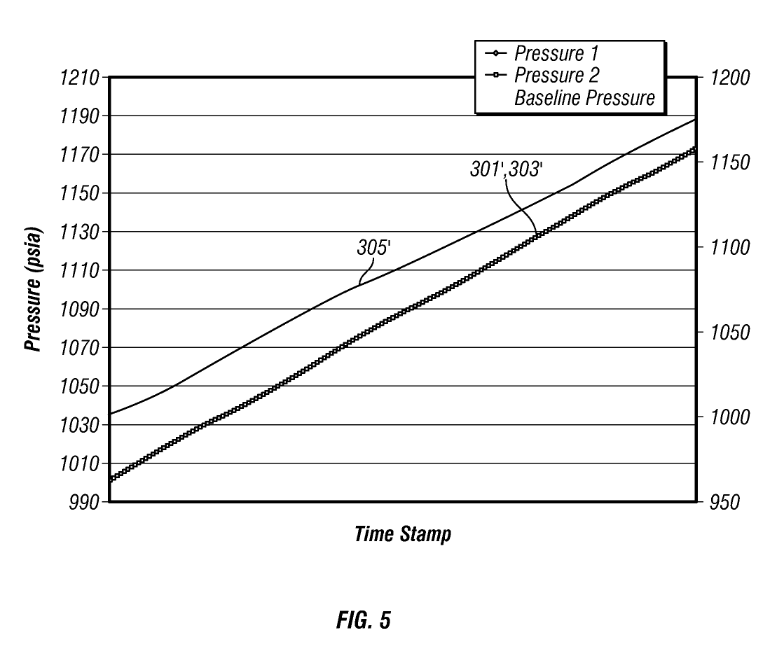

The frequency of rotation can be determined based on the time base and the amount of rotation over a set period. FIG. 4 is for the case when there is no increase in baseline pressure. However, in the real scenario in which a tool is run into a well the base pressure will be increasing based on a certain trend. FIG. 5 demonstrates a steady increase in pressure as the tool is run in. As can be seen the baseline pressure 305′ is superimposed on to the rotation pressure. Therefore pressure 301′ and 303′ shows an increasing trend like the baseline pressure with some amount of variability in the line. The sinusoidal variation in sensor pressure is barely discernible.

It is not as obvious looking at FIG. 5 what is the frequency and how many rotations have occurred because the amount of pressure change due to rotation is much smaller than that seen in the change due to the tool being run in the hole. In one embodiment of the disclosure, an arithmetic correction is applied using the well deviation from vertical (υ), measured depth (MD), run-in rate ( [symbol] ), elapsed time (t) and fluid density (ρ) given by the following relationship:

P_{abs}=P_{ambient}+(Rt sin(υ))·ρ (3)

Applying this correction to the sensor measurements 301′, 303′ gives something similar to the sinusoids of FIG. 4.

In another embodiment of the disclosure. a statistical analysis may be done to determine the rotation of the tool. Denoting by S(t) the difference between measurements S₁(t) and S₂(t) made by the two sensors, it is seen from FIG. 4 that S(t) has a maximum (or minimum) when the tool is oriented at the baseline (defined by A1 and A2) and is zero when the tool is orthogonal to the baseline, i.e., at B and C. Thus, the phase of S(t) is an indication of the orientation of the gauge in the well. The use of the phase of the difference signal is quite clear when the signal is monochromatic, i.e., the tubing has a uniform rate of rotation. This principle can be extended to the case of a non-uniform rate of rotation using the concept of an instantaneous frequency and phase for a signal that is not monochromatic.

Following the method disclosed in Taner (Geophysics v 44 no 6, pp 1041-1063, 1979), we denote S(t) as

S(t)=A(t)cos θ(t) (4),

where A(t) is the instantaneous amplitude and θ(t) is the instantaneous phase. The quadrature trace S*(t) is then defined as

S*(t)=A(t)sin θ(t) (5).

The quadrature trace S*(t) may be obtained as the Hilbert transform of S(t):

$${S}^{*} ( τ ) = \frac{1}{π} P . V . {\int }_{- ∞}^{∞} \frac{S ( t )}{τ - t} d t , \qquad ( 6 )$$

where P.V.

$${\int }_{- ∞}^{∞}$$

is the Cauchy Principal value.
Once the quadrature trace has been determined, the instantaneous phase is given by

$$θ ( t ) = {tan}^{- 1} ( \frac{{S}^{*} ( t )}{S ( t )} ) , \qquad ( 7 )$$

and, as noted above, can be used to estimate the orientation of the gauge.
It should be noted that the instantaneous frequency of S(t) is given by

$$ω ( t ) = \frac{d θ ( t )}{d t} .$$

An alternate method of estimating the instantaneous phase of S(t) is from the Short-Term Fourier Transform (STFT). The conventional Fourier transforms (FT, DTFT, DFT, etc.) do not clearly indicate how the frequency content of a signal changes over time. That information is hidden in the phase—it is not revealed by the plot of the magnitude of the spectrum. To see how the frequency content of a signal changes over time, we can cut the signal into blocks and compute the spectrum of each block.

To improve the result,

1. blocks are overlapping

2. each block is multiplied by a window that is tapered at its endpoints.

It should be noted that the gauge carrier is only an example of devices that may be conveyed into a borehole on a tubular: the method described above may be used to determine the orientation of any downhole device (including, but not limited to perforating tools), and the conveyance device is not limited to tubular strings and may include a wireline. It should be further noted that for the specific case discussed above i.e., pressure sensors on a gauge carrier, once the orientation of the carrier is known, measurements by the pressure sensors can be used to estimate velocity of flow and holdup for gas-liquid flow in a deviated well. This is discussed in U.S. Pat. No. 5,633,470 to Song, having the same assignee as the present disclosure and the contents of which are incorporated herein by reference. As discussed in Song, the method includes measuring the velocity of the gas, measuring the velocity of the liquid, calculating a fractional amount of the cross-sectional area of the conduit occupied by the gas and occupied by the liquid, and calculating the volumetric flow rates from the measurements of velocity and from the calculated fractional amounts of the cross-sectional area of the conduit occupied by the gas and by the liquid. The gas velocity may be measured by cross-correlating measurements of two spaced-apart temperature sensors after momentarily heating the gas, and the liquid velocity may be measured by a spinner flow meter.

Implicit in the processing of the data is the use of a computer program implemented on a suitable machine-readable medium that enables the processor to perform the control and processing. The machine readable medium may include ROMs, EPROMs, EAROMs, Flash Memories and Optical disks.

Thus, in one aspect, the disclosure provides a method of estimating an orientation of a downhole device conveyed into a well. The method according to one embodiment may include: producing a first signal and a second signal indicative of a downhole parameter using a first sensor and a second sensor disposed circumferentially apart on the downhole device when the downhole device is conveyed into the well; estimating a phase difference between the first signal and the second signal; and estimating the orientation of the downhole device using the estimated phase difference. The method may further include selecting the downhole device, including, but not limited to a gauge carrier and a perforating device. In another aspect, the device may be conveyed into the well using any suitable device, including, but limited to a drilling tubular, a coiled-tubing and a wireline. In another aspect, estimating the phase difference may further comprise applying a correction for a run-in of the downhole device. In yet another aspect, applying the correction may comprise using a well deviation from vertical, a measured depth, a run-in rate and a fluid density of a fluid in the well. In yet another aspect, estimating the phase difference may comprise one or more of: applying a Short Term Fourier Transform; and estimating a quadrature signal of the phase difference between the first signal and the second signal. In one embodiment, the sensors may be pressure sensors. In another aspect, estimating the phase difference between the first signal and the second signal and estimating the orientation of the downhole device comprise may comprise using a processor to process the first signal and the second signals. The processing of the first signal and the second signal may comprise processing the first signal and the second signal at a location selected from a group consisting of: a downhole location; a surface location; and partially in the well and partially outside the well.

In another aspect, an apparatus for estimating orientation of a downhole device is disclosed. In one embodiment, the apparatus includes: a first sensor and a second sensor placed circumferentially spaced apart on the downhole device, wherein each sensor is configured to provide measurements relating to a selected parameter; and a processor configured to estimate a phase difference between the measurements of the first sensor and the second sensor and estimate the orientation of the downhole device using the estimated phase difference. In one aspect, the processor may be further configured to estimate the orientation of the downhole device by applying a correction for a run-in of the downhole device. In yet another aspect, the processor may be further configured to apply the correction using a well deviation from vertical, a measured depth, a run-in rate and a fluid density. In yet another aspect, the processor may be further configured to estimate the orientation of the downhole device by at least one of: (i) applying a Short Term Fourier Transform, and (ii) estimating a quadrature signal of the phase difference between the first signal and the second signal. In one configuration, the sensors may be pressure sensors. In another configuration, the apparatus may include: a tool configured to be conveyed in the well, the tool including a first sensor and a second sensor disposed circumferentially spaced from each other, each sensor configured to provide measurements relating to a downhole parameter; and a processor configured to: (i) estimate a phase difference between the measurements of the first sensor and the second sensor; and (ii) estimate the orientation of the downhole device using the estimated phase difference.

In yet another aspect, the disclosure provides for a computer-readable medium that includes thereon a program containing a set of instructions that when read by a processor enable the processor to perform a method as disclosed herein above. In another aspect, one embodiment of the program may include: instructions to estimate a phase difference between a first signal provided by a first sensor and a second signal provided by a second sensor when the first sensor and the second sensor are deployed circumferentially apart on a downhole device in a well; and instructions to estimate an orientation of the downhole device using the estimated phase difference. In another aspect, the program may further include instructions to estimate the phase difference by applying a correction for a run-in of the downhole device. In yet another aspect the program may include instructions to a well deviation from vertical, a measured depth, a run-in rate and a fluid density of a fluid in the well to apply the correction. In another aspect, the program may include instructions to estimate the phase difference using at least one of: (i) applying a Short Term Fourier Transform; and (ii) estimating a quadrature signal of the phase difference between the first signal and the second signal.

While the foregoing disclosure is directed to the specific embodiments of the disclosure, various modifications will be apparent to those skilled in the art. It is intended that all variations within the scope and spirit of the appended claims be embraced by the foregoing disclosure.

What is claimed is:

1. A method of estimating an orientation of a downhole device conveyed into a well, the method comprising:
producing a first signal and a second signal indicative of a downhole parameter using a first sensor and a second sensor disposed circumferentially apart on the downhole device when the downhole device is conveyed into the well;
estimating a phase difference between the first signal and the second signal; and
estimating the orientation of the downhole device using the estimated phase difference.

2. The method of claim 1 further comprising selecting the downhole device from: (i) a gauge carrier, and (ii) a perforating device.

3. The method of claim 1, wherein the device is conveyed into the well using a conveyance device selected from one of: (i) a tubing; and (ii) a wireline.

4. The method of claim 1, wherein estimating the phase difference further comprises applying a correction for a run-in of the downhole device.

5. The method of claim 4, wherein applying the correction further comprises using a well deviation from vertical, a measured depth, a run-in rate and a fluid density of a fluid in the well.

6. The method of claim 1, wherein estimating the phase difference comprises at least one of: (i) applying a Short Term Fourier Transform; and (ii) estimating a quadrature signal of the phase difference between the first signal and the second signal.

7. The method of claim 1, wherein the first sensor and the second sensor are pressure sensors.

8. The method of claim 1, wherein estimating the phase difference between the first signal and the second signal and estimating the orientation of the downhole device comprises using a processor to process the first signal and the second signals.

9. The method of claim 8, wherein the processing of the first signal and the second signal comprises processing the first signal and the second signal at a location selected from a group consisting of: (i) a downhole location; (ii) a surface location; and (iii) partially in the well and partially outside the well.

10. An apparatus for estimating orientation of a downhole device, the apparatus comprising:
a first sensor and a second sensor placed circumferentially spaced apart on the downhole device, each sensor configured to provide measurements relating to a selected parameter; and
a processor configured to estimate a phase difference between the measurements of the first sensor and the second sensor and estimate the orientation of the downhole device using the estimated phase difference.

11. The apparatus of claim 10 wherein the processor is further configured to estimate the orientation of the downhole device by applying a correction for a run-in of the downhole device.

12. The apparatus of claim 11 wherein the processor is further configured to apply the correction using a well deviation from vertical, a measured depth, a run-in rate and a fluid density.

13. The apparatus of claim 10 wherein the processor is further configured to estimate the orientation of the downhole device by at least one of: (i) applying a Short Term Fourier Transform, and (ii) estimating a quadrature signal of the phase difference between the first signal and the second signal.

14. The apparatus of claim 10, wherein the first sensor and the second sensor are pressure sensors.

15. A computer-readable medium having stored thereon instructions that when read by a processor enable the processor to perform a method, the method comprising:
estimating a phase difference between a first signal provided by a first sensor and a second signal provided by a second sensor when the first sensor and the second sensor are deployed circumferentially apart on a downhole device in a well; and
estimating an orientation of the downhole device using the estimated phase difference.

16. The computer-readable medium of claim 15, wherein estimating the phase difference further comprises applying a correction for a run-in of the downhole device.

17. The computer-readable medium of claim 16, wherein applying the correction comprises using a well deviation from vertical, a measured depth, a run-in rate and a fluid density of a fluid in the well.

18. The computer-readable medium of claim 15, wherein estimating the phase difference comprises at least one of: (i) applying a Short Term Fourier Transform; and (ii) estimating a quadrature signal of the phase difference between the first signal and the second signal.

19. The computer-readable medium of claim 15, wherein the first signal and the second signal are pressure signals relating to pressure in the well.

20. An apparatus for use in a well, comprising:
a tool configured to be conveyed in the well, the tool including a first sensor and a second sensor disposed circumferentially spaced from each other, each sensor configured to provide measurements relating to a downhole parameter; and
a processor configured to:
(i) estimate a phase difference between the measurements of the first sensor and the second sensor, and
(ii) estimate the orientation of the downhole device using the estimated phase difference.
